(19) United States
(12) Patent Application Publication
(10) Pub. No.: US 2011/0100180 A1
(43) Pub. Date: May 5, 2011

(54) METHOD AND DEVICE FOR PORTIONING A PLURALITY OF DOUGH STRANDS INTO INDIVIDUAL DOUGH PORTIONS

(76) Inventors: Herbert Mülders, Stolberg (DE); Dieter Knost, Dinkelsbuhl (DE)

(21) Appl. No.: 12/894,750

(22) Filed: Sep. 30, 2010

(30) Foreign Application Priority Data
Oct. 1, 2009 (DE) 10 2009 043 668.5

(51) Int. Cl. A21C 5/00; A21D 6/00; A23P 1/00

(52) U.S. Cl. 83/401; 426/503

(57) ABSTRACT

A device for portioning a plurality of dough strands into individual dough portions operates as follows: firstly, the produced dough strands, which are transported by a conveyor device, are measured with respect to their volume by a measuring device. Afterwards the dough strands are cut by means of a cutting device as a function of the measurement result into dough portions. This results in a dough portioning where the precision of the portioning is improved.

### FIELD OF THE INVENTION

The invention relates to a method and a device for portioning a plurality of dough strands into individual dough portions.

### BACKGROUND OF THE INVENTION

A dough strand portioning method and a device for performing the latter are known from prior use.

### SUMMARY OF THE INVENTION

An object of the present invention is to develop a method and a device for portioning a plurality of dough strands into individual dough portions such that the precision of the portioning is improved.

This object is achieved according to the invention by a method for portioning a plurality of dough strands into individual dough portions with the steps of producing the dough strands, measuring the volume of the dough strands, and cutting the dough strands as a function of the measurement result into dough portions. This objective is further achieved according to the invention by a device for portioning a plurality of dough strands into individual dough portions with a conveying device for the produced dough strands, with a measuring device for measuring the volume of the dough strands, and with at least one cutting device for cutting the dough strands as a function of the measurement result into dough portions.

In accordance with the invention it has been established that by measuring the volume of the dough strands the portion can be defined precisely. This results in an advantageous reduction of portioning tolerances, so that a safety volume or weight allowance, which is usually provided in known portioning methods, can be reduced or avoided completely. Because of the reproducible portioning, which can be performed for example with a precision of ±2% or ±1%, the baked product is also a uniform size. A plurality of dough strands can be processed in parallel, for example two, three, four, five, six, eight, ten or even more dough strands. Said dough strands can be measured individually with respect to their volume, so that each of the dough strands can be portioned individually accordingly. From the measurement of the volume a precise definition of the weight, which is generally sufficient for the portioning, can be obtained with high precision, as in general a good approximation to a constant density of the dough strands can be assumed. In this way during the dough strand measurement according to the invention the measured volume is precisely the variable responsible for fluctuations in weight and portioning. As often occurs with portion measurements which are based on density measurements the consistency of the cross section of the dough strand is not presupposed.

In a method with an additional density measurement measuring the density of the dough strands prior to cutting, exact weight portions can be obtained. The density measurement can be performed by an ultrasound measurement. Alternatively, a density measurement can also be performed by an electrical conductivity measurement and/or by a capacitive sensor for measuring the dough strand.

An optical volume measurement can be performed very precisely. In this case an optical 3D scanning measurement, a split-beam measurement or other imaging measurement technique known from optical image processing can be used. In said optical volume measurement optical wavelengths are used, i.e. wavelengths in the visible range (380 nm to 780 nm).

A cutting variant in which all of the dough strands are cut using the same cutting device in a cutting step performed jointly for all of the dough strands, enables the rapid portioning of many dough portions. The exact cutting position can be determined by an error square definition as a function of the measured volume and/or as a function of the measured density, so that several dough portions obtained with one cut deviate as little as possible in volume or weight from defined values. Depending on the precision of the preceding dough strand production by means of such a cutting method a precision of up to ±2% can be achieved for the portions.

In a cutting variant with individual cutting devices in which each dough strand is cut by a cutting device assigned individually to the dough strand and controlled individually depending on the respective dough strand measurement result, a portioning speed can be reached which corresponds to that of the first described cutting variant. In addition, for all dough strands individual precise dough portions can be produced.

A cutting variant in which all of the dough strands are cut by the same cutting device in cutting steps performed individually for the dough strands, combines the advantages of involving less structural effort of the first described cutting variants with strand-individual dough portioning according to the second described cutting variant. The cutting device can be designed as a cutting device running behind the conveying device. A movement track of the cutting device during the portioning process can be provided by a corresponding control and a corresponding control software with an optimized position between the conveying tracks for the dough strands.

The movement of a cut-off dough portion by the cutting device in which after cutting the cutting device moves the cut off dough portion relative to the remaining dough strand along a predefined path along the conveying direction, enables the advantageous separation of the dough portions in conveying direction for subsequent processing.

The subsequent adjustment of a dough strand width by detecting a position of the cutting device along the conveying direction, whereby depending on the detected position a dough strand width of the conveyed dough strand is determined, increases the throughput of the portioning process, as in this way the operating mode of the cutting device can be optimized. Also the precision of the portioning can be improved, for example when cutting all of the dough strands using the same cutting device, by subsequently controlling the width of the dough strand.

The advantages of a portioning device according to the invention correspond to those that have already been described above with reference to the portioning method according to the invention. In the portioning device precisely one cutting device can be used. Also two or more cutting devices can be used.

An exemplary embodiment of the invention is explained in more detail in the following with reference to the drawing.

### BRIEF DESCRIPTION OF THE DRAWING

FIG. 1 shows schematically in plan view the main components of a device for portioning a total of five dough strands into individual dough portions, wherein a conveyor belt of a conveying device is only shown in sections;

FIG. 2 shows schematically the optical main components of a measuring device of the portioning device for measuring the volume of the dough strands, wherein only one of two sensors is shown;

FIG. 3 shows schematically the position ratios for measuring the five dough strands shown in cross section in turn with a shown sensor;

FIG. 4 shows a side view of a cutting device of the portioning device for cutting the dough strands; and

FIG. 5 shows a plan view according to the direction of view V in FIG. 4.

### DESCRIPTION OF THE PREFERRED EMBODIMENT

A portioning device 1 is used for portioning a plurality of dough strands 2, in the shown exemplary embodiment five dough strands 2, into individual dough portions 3.

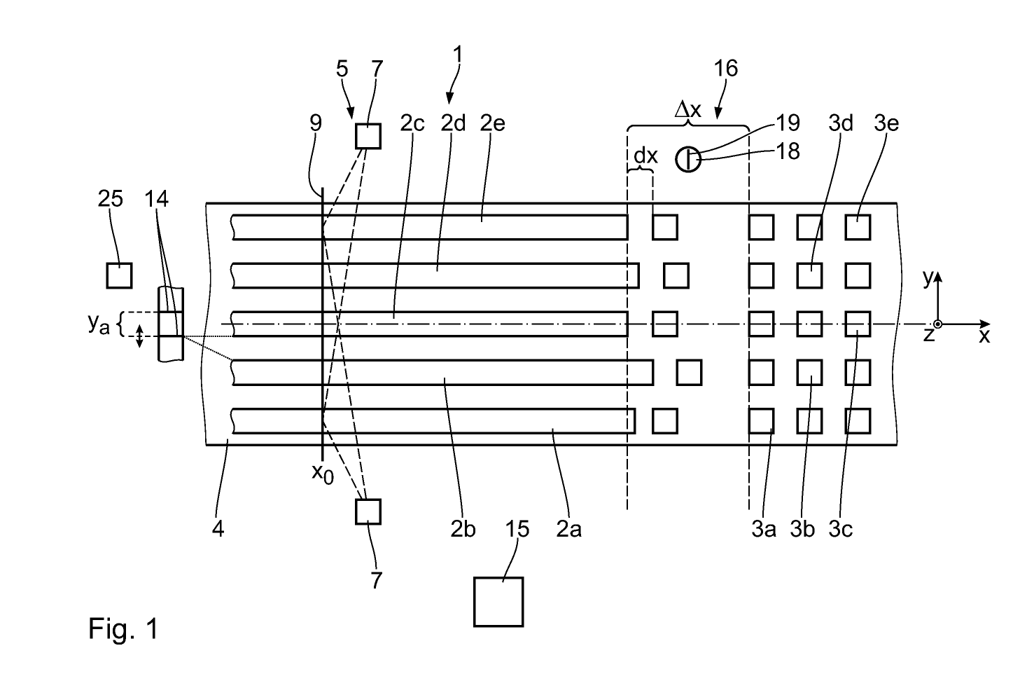

To simplify the explanation of relative positions in the drawing a Cartesian xyz coordinate system is used. The x-direction runs in FIG. 1 to the right and parallel to the conveying direction of a conveying device of the portioning device 1, of which only a section of a conveying belt 4 is shown in FIG. 1. The y-direction runs upwards in FIG. 1, where an upper strand of the conveyor belt 4 supporting the dough strands 2 and the dough portions 3 has a conveying plane, which is extended by the xy-plane. The z-direction of the coordinate system runs in FIG. 1 perpendicular to the plane of the drawing towards the observer. The dough strands 2 are provided in FIG. 1 with lowercase letters from 2a to 2e from bottom to top. The same applies to the allocation of letters for the dough portions 3.

The conveying speed of the conveyor belt 4 is in a range from 5 m/min to 10 m/min and is in particular 8 m/min.

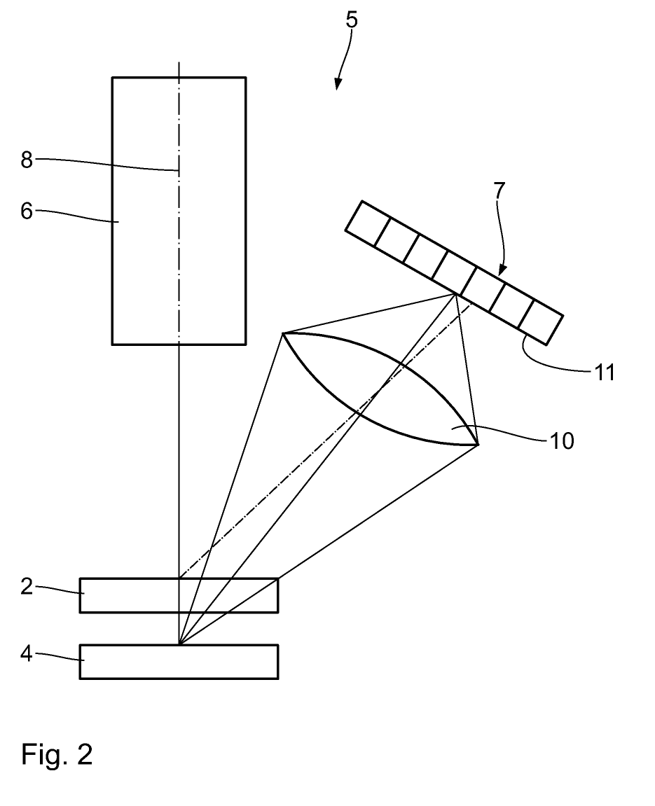

To measure the volume of the individual dough strands 2a to 2e a volume measuring device 5 is used with a laser light source 6 and two CCD/PSD-(Charged Coupled Device/Position Sensitive Detector) detector units 7. The structure of the volume measuring device 5 with precisely one CCD/PSD detector unit 7 is shown schematically in FIG. 2. The second of the two detector units 7 is arranged in mirror image about the xz-middle plane 8 in FIG. 2.

By means of a signal connection not shown in more detail the detector units 7 are connected to a central control/regulating device 15 of the portioning device 1.

For the volume measurement the laser light source 6 produces by means of the split-beam method a linear light curtain 9, which extends perpendicular to the longitudinal extension of the dough strands 2a to 2e parallel to the yz-plane. The light curtain 9 thus illuminates at a given time point precisely one slice of the dough strands 2a to 2e at the site x₀ of the light curtain 9.

The dough strand slice illuminated by the light curtain 9 is displayed by an objective 10 shown in FIG. 2 schematically as a lens on a CCD/PSD-sensor element 11 of the CCD/PSD detector unit 7.

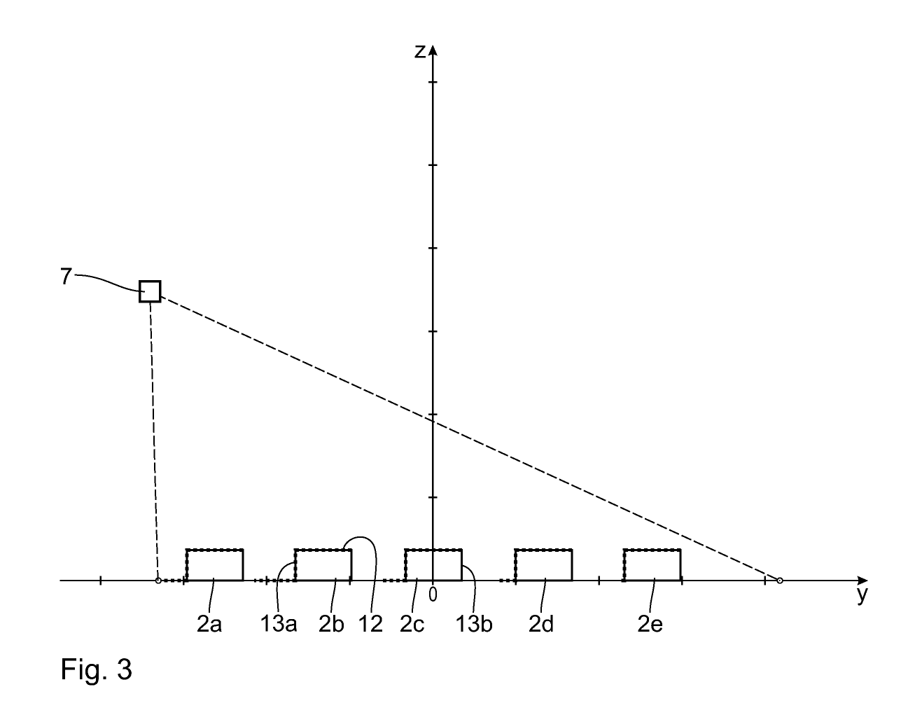

FIG. 3 shows which area sections of the dough strands 2a to 2e, which are shown in FIG. 3 in cross section, can be determined by one of the two detector units 7. One of the two detector units 7 respectively is in a position to determine optically an upper side 12 and a side wall 13a of the respective dough strand 2a to 2e facing said detector unit 7. The other of the two detector units 7 can determine in addition to the upper side 12 the other of the two side walls, i.e. the side wall 13b, of the dough strands 2a to 2e. From the measurement data of the two detector units 7 the profile of the dough strand slice of the dough strands 2a to 2e scanned by the light curtain 9 at site x₀ can be determined precisely. Therefore, during the conveying of the dough strands 2a to 2e along conveying direction x the optical volume measuring device 5 determines, taking into consideration the conveying speed of the conveying belt 4 by integration, the volume of the dough strands 2a to 2e conveyed past site x₀. Said volume is dependent on the width of the dough strands 2 in y-direction, i.e. on the distance yₐ between two adjacent longitudinal cutting blades 14, which in cooperation cut out the respective dough strands 2 from a flat dough band. Between the x-position of the longitudinal cutting blade 14 and the dough strands 2a to 2e shown next to one another and spaced apart from one another in FIG. 1 a dough strand spreading device is arranged, which is not shown in the drawing. The volume of the dough strands 2 is also dependent on the vertical profiling of the dough strands 2, i.e. on the function h(x, y), whereby h represents the height of the respective dough strand 2 above the level of the conveyor belt 4 at site x, y.

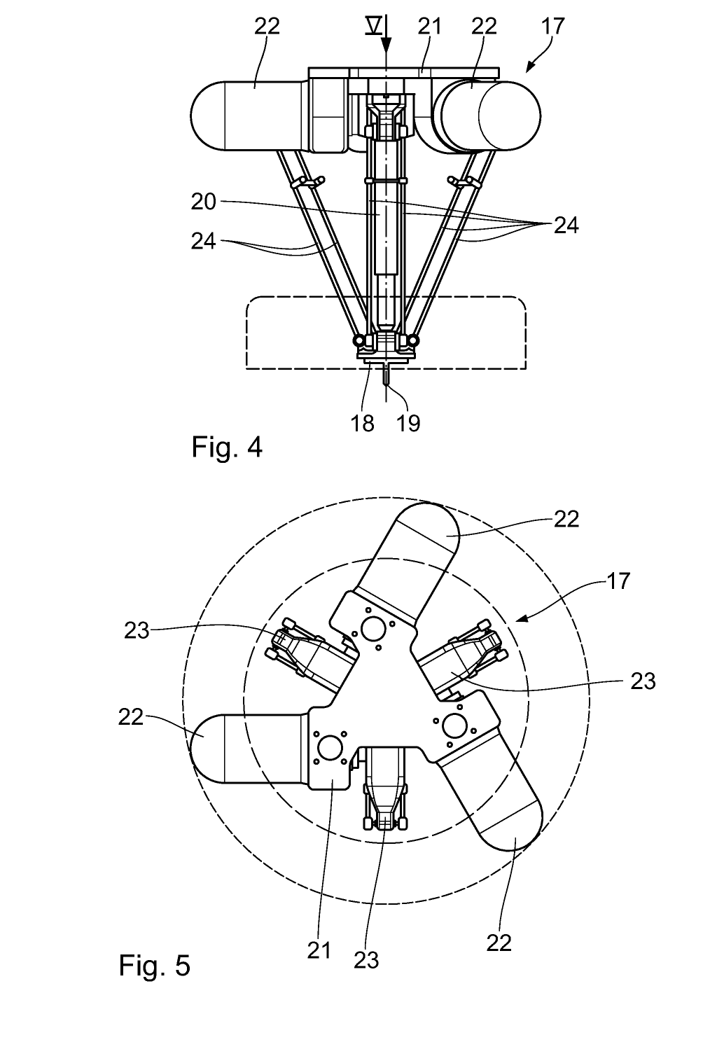

In the conveying direction x of the volume measuring device 5 a cutting device 16 is arranged for cutting the dough strands 2a to 2e according to the measurement result of the volume measuring device 5 into dough portions 3a to 3e. The cutting device 16 has a cutting head 17 which is movable in three degrees of freedom, which is shown in more detail in FIGS. 4 and 5. The cutting head 17 has a holding disc 18, onto which a cutting edge 19 of a cutting blade is secured. The holding disc 18 represents the end of a central head rod 20 of the cutting head 17. The head rod 20 is articulated by a spherical/socket joint onto a frame plate 21. The frame plate 21 is arranged guided movably on a guiding frame not shown in more detail in y-direction and within an area Δx indicated in FIG. 1 also in x-direction. Three servomotors 22 of the cutting head 17 are secured onto the frame plate 21. Drive shafts of the servomotors 22 are connected in a non-rotatable manner to connecting rods 23, the lever ends of which are connected by pull rod pairs 24 to the holding plate 18. By means of the three servomotors 22 and the x- and y-drive of the not-shown guiding frame the cutting edge 19 can be moved in five independent degrees of freedom. The component group shown in FIGS. 4 and 5 apart from the cutting edge is a robot, which is known in a comparable design under the name Flex Picker or Delta Robot made by the companies Kuka, Festo, Bosch and ABB.

The cutting edge 19 is wider than the width of one of the dough strands 2 in y-direction.

The cutting device 16 is also in signal connection with the central control/regulating device 15. Also a movement drive 25 shown schematically in FIG. 1, by means of which the longitudinal cutting blades 14 can be displaced relative to one another for the dough strand width definition and relative to the conveyor belt 4 in y-direction, is in signal connection with the central control/regulating device 15.

Dough portioning is performed with the positioning device 1 in the following manner: firstly in a known manner the dough strands 2a to 2e are produced. In this case a dough band is laminated and guided by the conveyor belt 4 past the longitudinal cutting blades 14 so that after spreading with the dough strand spreading device the dough strands 2a to 2e according to FIG. 1 are produced. Afterwards by means of the volume measuring device 5 the volume of the dough strands is measured during the conveyance in x-direction. Then the dough strands 2a to 2e are cut as a function of the measurement result by the cutting device 16 into the dough portions 3a to 3e. The x-distance between two cuts, which define a dough portion 3, is dependent on the volume, which results in turn in different x-cut positions of the cutting device 16, as indicated within the area Δx in FIG. 1. According to this area Δx the dough portions 3 are synchronized in relation to one another so that the dough portions 3a to 3e during the following conveyance can be provided in matrix form and spaced apart from one another in columns and rows.

When cutting the dough strands 2a to 2e the cutting device 16 is guided by the various drives, i.e. the y-drive, the x-drive and the three servomotors 22 so that all dough strands 2a to 2e are cut by said individually assigned cutting edges. With one cut of the cutting edge 19 precisely one of the dough strands 2a to 2e is cut. During the cutting process the cutting device 16 can follow behind the dough strands 2 within area Δx. The movement of the cutting device 16 between the dough strands 2a to 2e between the individual cuts and also the sequence of the individual cuts are predefined in a path-optimized manner by the central control/regulating device 15.

After the cutting the cutting device 16 can move the just cut dough portion 3 in relation to the remaining dough strand 2 along a predefined path dx (compare FIG. 1) along the conveying direction x. For this the cutting edge 19 lifts immediately after the cutting only a small amount in positive z-direction from the conveyor belt 4 and then, whilst the cutting edge 19 is still in contact with the just cut dough portion 3, is moved in positive x-direction by the predefined path dx. In this way the cutting edge 19 pushes the dough portion 3 into position.

By means of the x-guiding of the cutting device 16 the x-position of the cutting device 16 can be determined. The x-position is conveyed by a not shown signal connection to the central control/regulating device 15. Provided that the central control/regulating device 15 with a specific dough strand 2 receives an x-cutting position from the detecting device, which lies in the Δx-area outside a narrower and predefined cutting tolerance area, the central control/regulating device 15 changes via a corresponding control of the movement drive 25 the distance of the two longitudinal cutting blades 14 assigned to the said dough stand 2, such that in the further progression to produce the predefined dough portions 3 in this dough strand 2 an x-cutting distance is required, by means of which there is a return of the cutting device 16 into the predefined x-tolerance range within the area Δx. If for example the dough portions 3 are expanded in x-direction, the cuts are thus spaced too far apart from one another in x-direction, by controlling the movement drive 25 the associated dough strand 2 is widened, so that after this the same dough portions 3 can be portioned with more closely adjacent cuts in x-direction. The robot cutting system, as described here, and depending on the necessary output, can be designed individually or as a combination of several cutting devices 16, which can also be designed as so-called bending-arm robots, or can also be formed by a combination of robots with different kinematics. The robot controlled cuts can be used for separating the portions or also for making incuts (notches) in the portions (for tearing off later e.g. after baking) for decoration. A combination of cutting, notching and if necessary decorative cutting is possible.

Alternatively or in addition thereto as well as the volume also the density of the dough strands 2a to 2e can be measured, for example by an ultra-sound measurement. The density measurement can also enter into the dough portioning, so that for example dough portions can be produced that do not have a constant volume, but dough portions are produced with a constant weight. If no simultaneous and continual density measurement is made and it is appropriate for the calculations of the cutting positions, the density of the dough strands 2 to be cut can be entered into the control as a constant. Later during the course of production, in particular with a change in batch or type, the necessary corrections to the density are entered in this case by +/− correction values.

Alternatively to the aforementioned cutting method the cutting device 16 can be designed with a cutting blade running perpendicular to the entire conveyor belt 4, so that all dough strands 2a to 2e can be cut with exactly one cut of the cutting blade. In this case all of the dough strands 2 are cut in a joint cutting procedure by exactly one cutting blade. The x-position of this cut is then determined by way of an error square optimized definition of the volume and/or the density of all of the dough strands, so that a predefined volume and/or a predefined weight of the dough portions 3 is achieved with the least error deviation for all five dough strands 2a to 2e.

In a further variant of the cutting device the individual dough strand conveyor belts, along which the dough strands 2a to 2e are conveyed on the conveyor belt 4, are assigned individual cutting blades, in the case of the portioning device 1 according to FIG. 1 five cutting blades, whereby each of these individual cutting blades only cuts the dough strand 2 assigned to it into dough portions 3.

The cutting blade with the cutting edge 19 can be designed as an ultrasound measurement device. At a given time point during the cutting of the dough strand 2 the cutting edge 19 can thus vibrate with ultrasound. Said ultra-sound vibration can be activated for example towards the end of the cutting process by the dough strand 2 or even during the entire cutting process. The ultrasound vibration can also be omitted depending on the dough to be portioned.

By means of the cutting device 16 for example 100 or more cutting processes per minute are possible.

By means of a suitable design of the cutting edge 19 in all of the above-referenced method variants when dipping the cutting edge 19 into the dough strand 2 prior to the actual cutting of the dough portion 3 there is firstly a deformation of sections adjacent to the cut of the dough strand 2. This results in pulling of the dough prior to the cutting of the dough portion 3. This can be used for shaping the dough portion 3, in particular for forming a cushion.

By means of the portioning device 1 more than 20,000 dough portions 3 can be produced per hour.

In the variant with exactly one cutting blade by means of the portioning device 1 also a dough band not divided into dough strands can be positioned, which can be used for example for dough portioning during baguette or bread production.

The dough, from which the dough strands 2 are made, can be a multigrain dough or also a ciabatta dough.

What is claimed is:

1. A method for portioning a plurality of dough strands (2) into individual dough portions (3) with the following steps:
producing the dough strands (2a to 2e),
measuring the volume of the dough strands (2a to 2e),
cutting the dough strands (2a to 2e) as a function of the measurement result into dough portions (3a to 3e).

2. A method according to claim 1, wherein in addition prior to cutting the density of the dough strands (2a to 2e) is measured.

3. A method according to claim 1, wherein the volume measurement is performed optically.

4. A method according to claim 1, wherein all of the dough strands (2a to 2e) are cut using the same cutting device in a cutting step performed jointly for all of the dough strands (2a to 2e).

5. A method according to claim 1, wherein each dough strand (2a to 2e) is cut by a cutting device assigned individually to the dough strand (2a to 2e) and controlled individually depending on the respective dough strand measurement result.

6. A method according to claim 1, wherein all of the dough strands (2a to 2e) are cut by the same cutting device (16) in cutting steps performed individually for the dough strands (2a to 2e).

7. A method according to claim 1, wherein after cutting the cutting device (16) moves the cut off dough portion (3) relative to the remaining dough strand (2) along a predefined path (dx) along the conveying direction (x).

8. A method according to claim 1, comprising detecting a position of the cutting device (16) along the conveying direction (x), whereby depending on the detected position a dough strand width (yₐ) of the conveyed dough strand (2) is determined.

9. A Device (1) for portioning a plurality of dough strands (2) into individual dough portions (3)
with a conveying device (4) for the produced dough strands (2a to 2e),
with a measuring device (5) for measuring the volume of the dough strands (2a to 2e),
with at least one cutting device (16) for cutting the dough strands (2a to 2e) as a function of the measurement result into dough portions (3a to 3e).

10. A Device according to claim 9, comprising a measuring device for measuring the density of the dough strands (2).

11. A device according to claim 9, comprising an optical volume measuring device (5).

12. A device according to claim 9, wherein a cutting blade of the cutting device is designed such that all dough strands (2a to 2e) can be cut by one cut of the cutting blade.

13. A device according to claim 9, wherein the cutting device comprises cutting blades assigned individually to separate dough strand conveyor belts.

14. A device according to claim 9, wherein a cutting blade (19) of the cutting device (16) is designed and driven such that all dough strands (2a to 2e) can be cut by said individually assigned cuts, whereby with one cut of the cutting blade (19) precisely one of the dough strands (2a to 2e) can be cut.

15. A device according to claim 9, comprising a longitudinal cutting device (14) for cutting the dough strands (2) from a dough band, wherein the spacing between two longitudinal cutting blades (14) of the longitudinal cutting device can be defined by a movement drive (25), and wherein a detecting device is provided for a position of the cutting device (16) along the conveying direction (x), wherein the detecting device is in signal connection with the longitudinal cutting device and a control/regulating device (15) so that depending on the detected position of the cutting device (16) a dough strand width (ya) of the conveyed dough strand (2) is determined.
